(19) United States
(12) Patent Application Publication
(10) Pub. No.: US 2012/0047668 A1
(43) Pub. Date: Mar. 1, 2012

(54) DEVICE FOR COLLECTING THE SOLID DEBRIS IN THE BATH AND THE MOLTEN METAL OF AN ELECTROLYTIC POT DESIGNED FOR THE PRODUCTION OF ALUMINUM, BY SCRAPING OF THE BOTTOM OF SAID POT

(75) Inventors: Stéphane David, Lomme (FR); Arnaud Wattel, Tourcoing (FR)

(73) Assignee: E.C.L., Ronchin (FR)

(21) Appl. No.: 13/319,470

(22) PCT Filed: May 10, 2010
(86) PCT No.: PCT/FR2010/000360

§ 371 Date: Nov. 8, 2011

(30) Foreign Application Priority Data
May 11, 2009 (FR) 0902252

(51) Int. Cl. B08B 1/00

(52) U.S. Cl. 15/93.1

(57) ABSTRACT

Collection unit, in particular a crust shovel designed to clean the anode holes, including a mobile vertical mast actuated by a first actuator, a frame fixed onto said mobile vertical mast and at least one articulated bucket, characterized in that said first actuator is at least one hydraulic jack fed by an hydraulic system arranged so that, at least when a second actuator actuates said bucket, the oil pressure in the chamber on the rod side is maintained at a substantially constant value making it possible to support a load corresponding to the weight of said collection unit, less a load of predetermined value, preferably lower than 1000 daN, and typically ranging between 200 and 600 daN. Advantageously, the portion of circuit feeding said chamber on the rod side is provided with a pressure regulator. With such a device, the debris may be collected by scraping the bottom of the cell without damaging it.

The invention relates to aluminum production using igneous electrolysis by means of the Hall-Héroult process. It more particularly relates to a device designed to collect solid debris immersed in, or floating upon, the electrolytic bath, and the molten metal, in particular mud coming from the electrolytic bath which accumulates on the bottom of the pot, as well as fragments of carbon and crust debris which occur in particular as a result of the various operations carried out before and during the removal of spent anodes.

Aluminum is produced industrially by igneous electrolysis, using the well-known Hall-Héroult process, in electrolytic cells. The plants contain a great number of electrolytic cells laid out in line, in buildings called potrooms or rooms, and electrically connected in series using connecting conductors, in order to make the best use of the floor area of the plants. The cells are generally laid out so as to form two or more parallel lines which are electrically linked to each other by end conductors. In each cell, the electrolyte bath and the molten metal are contained in a vessel, called an “electrolytic pot”, comprising a steel container, which is coated on the inside with refractory and/or insulating materials, and a cathode assembly located at the bottom of the pot. Anodes, typically made of carbonaceous material, are partially immersed in the electrolytic bath.

When running, an aluminium reduction plant requires work on the electrolytic cells, including replacement of spent anodes by new ones, sampling of molten metal and sampling or top-ups of electrolyte. In order to carry out this work, plants are generally equipped with one or more service units including an overhead traveling crane which can be relocated above and along the series of electrolytic cells, and one or more service modules each comprising a carriage able to be moved on the overhead traveling crane, and so handling and servicing devices such as shovels and hoists, commonly called “tools”. These service units are often called “Pot Tending Assemblies” (PTA) or “Pot Tending Machines” (PTM). The service module generally includes, attached to the carriage, a rotary frame, called a tool-holder turret, which is able to turn around a vertical axis and is interdependent with said tools. Each tool may be fixed to the end of a cable operated by a winch attached to said turret, or to the end of an arm, which may be telescopic and/or articulated.

One of the operations necessary during anode replacement is cleaning the zone which was occupied by the spent anode and which is to be occupied by the new anode. This zone is primarily made up of the bath and the molten metal but may contain a number of solid fragments which must be removed before fitting the new anode. During electrolysis, a hard crust of fluorinated cryolite and alumina forms on the upper surface of the bath. This crust has the advantage of storing the heat within the bath and so constitutes an effective heat-insulating envelope. But it is extremely hard and adheres to the wall of the anode block, so that it proves to be necessary to break it around the spent anode, in order to allow the latter to be extracted. Typically, the crust is broken using tools such as tapers, called “crust-breakers”. During removal of the spent anode, there is then an opening in the crust, which is left vacant until the new anode is fitted and which we will thereafter refer to as the “anode hole”. Breaking the crust and handling the spent anode block inevitably lead to the formation of solid pieces or parts which float upon, or remain in suspension in, the electrolytic bath, or fall to the bottom of the pot. It is then necessary to remove them by means of a collecting tool commonly called a “crust shovel”.

European patent application EP-A-0 440 488 describes an example of a crust shovel in conjunction with a special vehicle, distinct from the PTA. European patent application EP-A-0 618 313 describes, in not very great detail, an example of a PTA equipped with a device for breaking the crust in the vicinity of a spent anode as well as cleaning the anode hole. The crust shovel commonly used is a wrench made up of two buckets placed symmetrically in relation to a substantially vertical plane and articulated, swiveling around two substantially horizontal axes, which may be one and the same. Each bucket has a leading edge, also called a “blade”, opposite the leading edge of the other bucket. To collect the fragments, the crust shovel is plunged in open position into the bath and is then moved from open to closed position by using at least one actuator which works either directly on a bucket, or preferably on a connecting rod assembly designed to make the buckets rotate in a substantially symmetrical direction in relation to each other, the solid debris located between the two buckets being trapped, while the liquid medium, a mixture of electrolyte bath and molten metal can still escape, in particular through openings made in the walls of the buckets.

Conventionally, the opening and closing movement of the crust shovel is driven by actuation of a pneumatic jack which acts on a connecting rod assembly designed to transform the translation movement of the jack into two symmetrical rotation movements of the buckets. Before placing the new anode in the cell, it must be checked that all crust and carbon debris in the anode hole has been removed. As some of this debris may be lying on the bottom of the pot, it is necessary to plunge the crust shovel into the liquid medium made up of the bath and the metal so that its leading edges barely touch the bottom of the pot. But as the leading edges of the buckets describe circular trajectories when the crust shovel closes to collect the debris, operating the shovel is very tricky, because the cathode assembly which makes up the bottom of the pot is likely to undergo significant damage during this operation. To avoid such damage, the axis or axes of the buckets must be made to adopt a position at an altitude such that the leading edges of the buckets never touch the bottom of the pot during the operation, while being as close as possible to this bottom for efficient cleaning. However, this position is difficult to evaluate because there is no visual access to the bottom of the pot. In addition, because of the circular trajectory described by the blades, this theoretical position makes the crust shovel ineffective in the phases where the blades are furthest away from the bottom of the pot, it being likely that some of the debris remaining on the bottom of the pot may not be collected.

This anode hole cleaning operation using the crust shovel therefore encounters two antagonistic difficulties: either the shovel is too close to the bottom of the pot and is likely to damage it, or it is too far away and cleaning is inadequate. Whatever procedure is adopted, there remains a considerable risk of general electric and magnetic instability in the operation of the pot, leading to a drop in the output of the plant.

European patent application EP-A-1 178 004 proposes a solution likely to solve the problem presented in the previous paragraph. This solution involves using a bucket shovel assembled on a vertical arm, but not fixing the frame interdependent with the axes of the buckets directly onto said vertical arm. For this purpose, the frame is duplicated in a part called the “shovel-holder frame”, which remains interdependent with the arm attached to the tool-holder turret and in a part called the “bucket-support frame”, vertically mobile in relation to the shovel-holder frame so that, as the center of instantaneous of rotation of the buckets may move whereas the arm remains motionless in relation to the bottom of the pot, the leading edges of the buckets may be given a substantially rectilinear trajectory. The shovel may be placed so that its leading edges just touch the bottom of the pot throughout the shovel closing operation. However, such a solution makes the shovel mechanism much more complicated, with a complex connecting rod assembly for closing the buckets, including a load transmission rod, one end of which is articulated [ . . . ] on the buckets [ . . . ] and the other end of which is articulated on a rotary actuation rod, itself articulated on the bucket-support frame, said rotary rod being mechanically connected to the shovel-holder frame by means of a compensation rod articulated on the shovel-holder frame, said rotary rod being additionally made to rotate by means of an actuator jack, the point of application of which is interdependent with the bucket-support frame”. Such a solution makes it necessary to introduce into the crust shovel many adapters designed to function in a hostile environment and to undergo high amplitude vibrations, in particular because of the stresses associated with slamming the buckets. This involves frequent replacement of these parts that are prone to wear out quickly.

The goal set by the applicant was to achieve effective cleaning of the anode hole during anode replacement, without risk of damage to the bottom of the pot, using a simple, inexpensive tool that is easy to clean, service and maintain.

A first object according to the invention is a collection unit designed to collect the solid debris and mud in the liquid media of a cell for producing aluminum, such as the electrolytic bath and the molten metal, designed in particular for cleaning anode holes, comprising:
a) a vertical mast actuated by a first actuator, also called a lifting actuator, used to move said vertical mast in the vertical direction;
b) a frame fixed onto said vertical mast;
c) at least one articulated bucket, swiveling around a substantially horizontal axis, fitted to said frame, with a substantially horizontal leading edge, actuated by a second actuator, also called a closing actuator, interdependent with said frame, causing said bucket to adopt a rotary movement around said substantially horizontal axis,
   characterized in that said first actuator is composed of at least one hydraulic jack which includes a body, a piston together with a rod and a chamber on the rod side, and which is powered by a hydraulic system arranged so that, at least when the second actuator is activated, oil pressure in the chamber on the rod side is maintained at a substantially constant value allowing said jack to support a load corresponding to the weight of said collection unit, less a load of predetermined value, preferably lower than 1000 daN, and typically ranging between 200 and 600 daN. To achieve this, the portion of circuit powering said chamber on the rod side is advantageously provided with a pressure regulator or pressure compensation device.

Said first actuator includes at least one hydraulic jack which makes it possible to move vertically said vertical mast to which the rest of the collection unit is attached. Preferably, the handling arm of the collection unit is telescopic, so that the rod of said hydraulic jack is interdependent with said vertical mast and the body of said hydraulic jack also moves vertically, actuated by an actuator interdependent with a mobile frame which moves in a horizontal plane, for example which is fixed to a carriage able to run along the beam of an overhead traveling crane. In this way, said collection unit may be moved quickly and positioned above the working area then brought down to the level of the anode hole to carry out the collecting operation.

Obviously, a “symmetrical” solution, involving making the mobile vertical mast interdependent with the body of the jack and the rod interdependent with the mobile frame, is also possible. According to the invention, the chamber which is active when the load rises is the one that is worked on. Since in both cases the collection unit is made to rise by applying pressure in the chamber on the rod side, a chamber which we will hereafter also refer to as the “rod-chamber”, it is on the hydraulic system supplying said chamber on the rod side that a pressure regulator is added.

According to the invention, the lifting actuator is made to operate in a compensation mode, which involves maintaining the pressure in the rod-chamber at a value which makes it possible to hold almost the full weight of said lifting unit, at least while the debris is being collected. The lifting unit is in a state close to hydraulic suspension, with an “apparent weight” limited to said predetermined value, preferably lower than 1000 daN, and typically ranging between 200 and 600 daN. As the risks of impacts are largely related to the substantially vertical movements of the collection unit when it is near the bottom of the pot, a significant reduction in its apparent weight makes it possible to limit the intensity of the force generated by the leading edge of the bucket coming into contact with the bottom of the pot when the bucket swivels to collect the fragments.

Said first actuator may include several hydraulic jacks. It is understood that, in this case, all the rod-chambers may be powered by the same circuit and they must be subjected, at least when the second actuator is activated, to a substantially constant pressure allowing all of said cylinders to support a load corresponding to the weight of said collection unit, less a load of a predetermined value, preferably lower than 1000 daN, and typically ranging between 200 and 600 daN.

Such a device makes it possible in particular to collect fragments by scraping the bottom of the pot, i.e. by letting the leading edge of the bucket move along the bottom of the pot while remaining continuously in contact with it: the collection unit, in quasi-hydraulic suspension, is practically free to move up or down depending on how open the bucket is. The bearing force, significantly lower than the actual weight of the collection unit, must however have a certain positive value, preferably limited to 1000 daN, and typically ranging between 200 and 600 daN, to prevent said collection unit from moving upwards too easily, in the event of difficulty in lifting certain fragments.

Advantageously, to perform all the raising and lowering functions with the same device, said first actuator also includes a chamber on the piston side which may be powered by the hydraulic system: this is a double-acting jack.

Obviously, fragments can be collected more easily if the collection unit includes a frame and two buckets fitted to said frame, placed symmetrically in relation to a substantially vertical plane and articulated, swiveling around two substantially horizontal axes, which may possibly be one and the same, each bucket having a leading edge opposite the leading edge of the other bucket. Preferably, the second actuator, interdependent with said frame, causes each of said buckets to make a substantially symmetrical rotation movement in relation to the substantially vertical plane, so that the solid debris located between the two buckets is trapped by said buckets. With such a device, the debris may be collected by scraping the bottom of the pot without damaging it.

According to the invention, the hydraulic system supplying the hydraulic jack acting as a first actuator comprises, at least at the moment when the second actuator is actuated, a pressure regulator, also called a pressure compensation device. The pressure regulator is a device designed so that it lets oil from the circuit run out to the pot when the pressure in the circuit reaches a certain higher critical value, and so that it supplies oil from the hydraulic unit when the pressure in the circuit reaches a certain critical lower value.

Advantageously, the first actuator which is used to move the vertical mast is a double-acting jack whose rod is interdependent with said collection unit, with a chamber on the rod side, called as the lower chamber, constantly able to cause said vertical mast to move vertically to the top, and a chamber on the piston side, called as the upper chamber, constantly able to cause said vertical mast to move vertically downwards. Advantageously, both chambers may be connected, via a distributor, to the “pressure line” or the “return line” of a hydraulic unit, the feeding circuit including several portions of circuits which make it possible to provide the following hydraulic feed configurations:
a) a differential configuration, where the chamber on the rod side and the chamber on the piston side are connected to the pressure line of the hydraulic unit, allowing the mast to descend at high speed;
b) a configuration corresponding to the rest position, the collection unit remaining suspended: the circuit is arranged so that said collection unit remains subjected to limited loads if it should encounter an obstacle as it moves vertically upwards or downwards;
c) a configuration in which the chamber on the rod side is connected to the pressure line of the hydraulic unit, corresponding to the upward movement of the collection unit;
d) a “compensation” configuration, corresponding to the phase when the collection unit scrapes the bottom of the pot, in which the pressure in the portion of circuit feeding the chamber on the rod side is controlled so as to be maintained around a value corresponding to the weight of said collection unit, less a load of predetermined value, preferably lower than 1000 daN, and typically ranging between 200 daN and 600 daN.

In the example given below, we describe these various operating phases of the collection unit in more detail.

Another subject according to the invention is a service module designed to be used in a plant for the production of aluminum by igneous electrolysis and comprising a carriage and handling and servicing devices, characterized in that it also includes a collection unit according to the invention, as described previously.

Another subject according to the invention is a PTA for a plant for producing aluminum by igneous electrolysis including an overhead traveling crane and characterized in that it also includes at least one service module according to the invention, as described previously.

Another object according to the invention is the use of a service module according to the invention for servicing work on electrolytic cells designed for the production of aluminum by igneous electrolysis, in particular for cleaning the anode holes.

FIG. 1 is a schematic cross-sectional view of a PTA in a typical potroom for the production of aluminum.

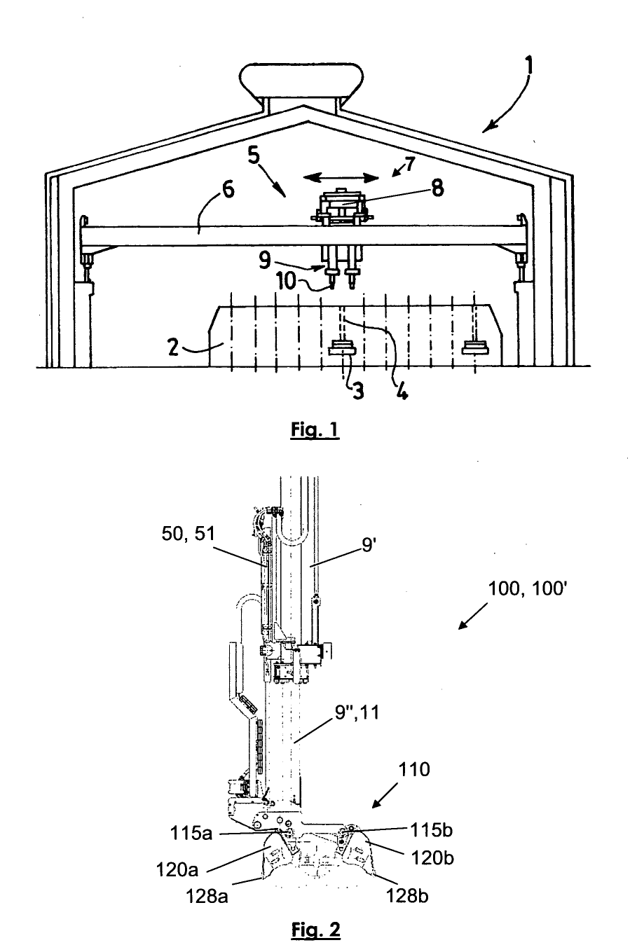

FIG. 2 illustrates a particular embodiment of a collection unit, which is a crust shovel, fitted to a telescopic vertical guide mast.

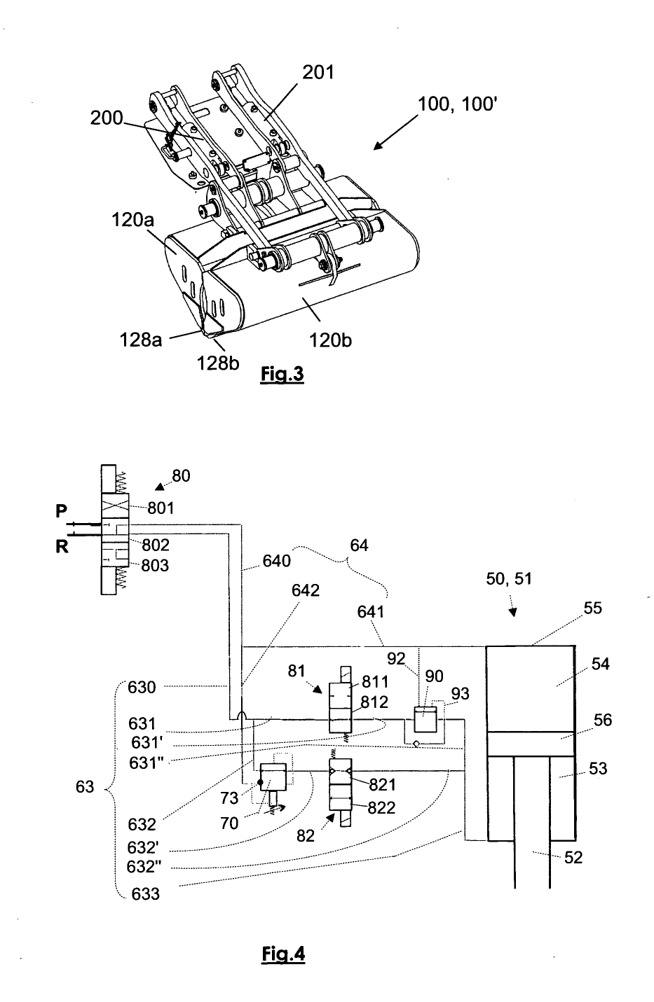

FIG. 3 is a perspective view of the connecting rod assembly and bucket shovel of the embodiment shown in FIG. 2.

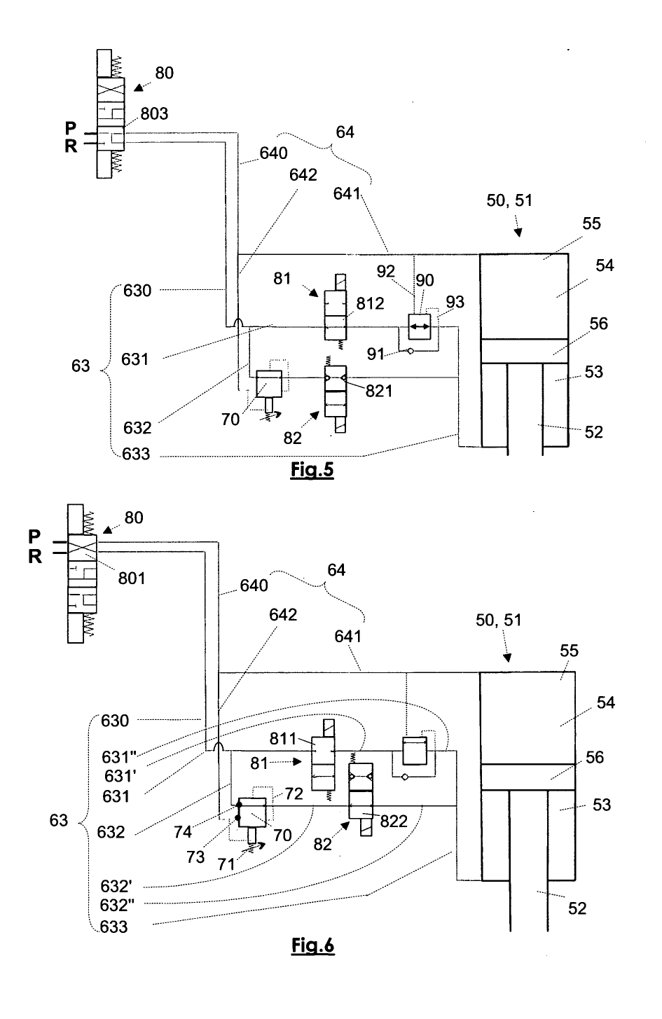

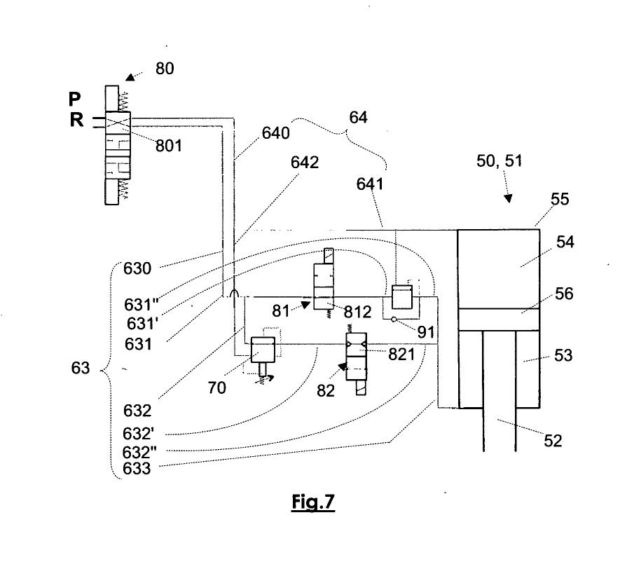

FIGS. 4 to 7 show four different configurations of a hydraulic circuit feeding the first actuator (lifting jack) for a collection unit according to the invention. These configurations correspond to the following operating processes: at rest (FIG. 4), fast descent (FIG. 5), compensation (the phase corresponding to scraping) (FIG. 6) and rising (FIG. 7).

Aluminium reduction plants include a liquid aluminum production area containing one or more potrooms. The potroom (1) illustrated in FIG. 1 comprises electrolytic cells (2) and a PTA (5). The electrolytic cells (2) are normally laid out in row or files, each row or file typically comprising over a hundred cells. The cells (2) are laid out so as to leave an aisle throughout the length of the potroom (1). Cells (2) include a series of anodes (3) provided with a metal rod (4) for fixing the anodes and connecting them electrically to a metal anode frame (not shown).

The PTA (5) is used to carry out operations on the cells (2) such as changing anodes or filling the feed hoppers with crushed bath and aluminum fluoride (AlF3). It can be also used to handle various loads, such as pot parts, molten metal ladles used during tapping operations (“tapping ladles”), or anodes. It may also be used to clean the anode hole, after the removal of a spent anode and before fitting a new anode.

The PTA (5) includes a overhead traveling crane (6) which may be moved above the electrolytic cells (2), and at least one service module (7) including a mobile carriage (8), called a “tool holder”, that can be moved on the overhead traveling crane (6) and equipped with several handling and servicing devices (10), such as tools, one of which may be a crust shovel (100′). The tools are here fitted onto vertical telescopic masts (9) attached to the mobile carriage (8). As we have already seen, for example in patent application European EP-A-0 440 488, a crust shovel may also be moved and operated from a vehicle other than a PTA. The invention applies to any collection unit, no matter how it moves and positions itself above the working area.

FIGS. 2 and 3 illustrate a particular embodiment of a collection unit (100), which is a crust shovel (100′) fixed to the end of a telescopic arm, at the end of the mobile arm, here called a “shovel stem” (11). The shovel stem is a mobile vertical mast (9″) sliding inside a vertical mast (9′), which also moves vertically, actuated by an actuator (not shown) interdependent with the tool-holder turret of the mobile carriage (8) of a service module (7). The crust shovel includes a frame (110) provided with two buckets (120a and 120b) placed opposite each other, substantially symmetrically in relation to a substantially vertical plane and articulated, swiveling around two substantially horizontal axes (115a and 115b). Each bucket (120a, 120b) has a leading edge (128a, 1286), opposite the leading edge (128b, 128a) of the other bucket (120b, 120a). The second actuator is here shown as two jacks (200, 201) interdependent with frame (110), functioning simultaneously, causing each bucket to make a substantially symmetrical rotary movement in relation to the substantially vertical plane, so that the solid debris located between the two buckets are trapped by said buckets.

### EXAMPLE OF AN EMBODIMENT

### FIGS. 2 to 7

FIGS. 4 to 7 show four different configurations of a hydraulic circuit feeding the first actuator (50) for a collection unit according to the invention, which additionally has the characteristics described above (FIGS. 2 and 3).

The first actuator, or lifting jack, (50) is a double-acting jack (51) with a body (55) and a piston (56) associated with a rod (52). The rod (52) is interdependent with the collection unit (not shown in FIGS. 4 to 7). The double-acting jack (51) has a chamber on the rod side (53), called as the lower chamber, able at any time to make the mobile vertical mast (9″) move vertically towards the top, and a chamber on the piston side (54), called as the higher chamber, able at any time to make said mobile vertical mast move vertically downwards. The hydraulic system includes two portions (63) and (64) which feed the two chambers (53) and (54) of the double-acting jack (51). The circuit may be connected, via a three-position distributor, which we will hereafter call the “direction distributor” (80), to the “pressure line” (P) and to the “return line” (R) of a hydraulic unit. The direction distributor (80) is naturally in rest position (802) and may be excited to be placed in one of the two other possible positions: position (803) in which rod (52) of the jack moves the collection unit down according to a differential mode, and position (801) in which the jack rod moves said collection unit up.

The first portion of circuit (64) includes a main branch (640), one end of which is connected to the direction distributor (80) and whose other end splits into two branches, the first branch (641) being connected to the piston-chamber (54) of jack (51), the second branch (642) being connected to the return opening (73) of the pressure regulator (70).

The second portion of circuit (63) includes a main branch (630) one end of which is connected to the direction distributor (80) and whose other end splits into two sub-branches, each of which is provided with a two-position distributor (81, 82), the first sub-branch (631, 631′, 631″) being associated with a shut-off valve (90), the second sub-branch (632, 632′, 632″) being associated with the pressure regulating device (70). The two sub-branches meet at their other ends to make up the end portion (633), which feeds the chamber on the rod side (53) of jack (51). The shut-off valve (90), when non-passing, fulfills two functions: it maintains the load (the collection unit) and performs a safety function, by limiting the pressure inside the rod-chamber in the event of an impact. These two functions could be fulfilled by other separate devices, for example a poppet valve, used as a load-retaining means, in conjunction with a pressure limiting device for safety.

FIG. 4 illustrates the circuit when the hydraulic jack is at test. The direction distributor (80) is naturally in position (802), which connects the two portions of circuit (63) and (64) to each other by means of their respective main branches (630) and (640). The distributor (82) is in position (821) which blocks circulation in the second sub-branch and makes the pressure regulator (70) inoperative. Isolated by distributor (82) in position (821) and by shut-off valve (90) which is non-passing (the control pressures of connections (92) and (93) are insufficient to make it passing), the chamber-rod (53) is maintained, provided it does not receive any impact, at a substantially constant pressure, associated with the weight of the collection unit. The branch of circuit (633) is provided with a safety device, integrated into the function of the shut-off valve (90), to limit the pressure in the rod-chamber in the event of an impact.

FIG. 5 illustrates the circuit when the hydraulic jack is moving down quickly. The direction distributor (80) is excited to occupy position (803), which makes the two portions of circuit (63) and (64) communicate with the pressure line (P) of the hydraulic unit, the two portions of circuit (63) and (64) also communicating with each other, by means of their respective main branches (630) and (640), at the level of the direction distributor (80) when it is in this position (803). Distributor (82) is in position (821) which makes the pressure regulator (70) inoperative. Distributor (81) is in position (812) and allows the shut-off valve (90) to operate: whenever the resultant of the forces due to the control pressures from branch (92) (“external control”) and branch (93) (via valve (91)—“internal control”) is higher than a certain value, the shut-off valve (90) becomes passing.

Shut-off valve (90) is set at a critical value, typically around 180 bar, so that, as soon as its controls have sufficient pressures, it becomes passing and oil can run out of rod-chamber (53) towards piston-chamber (54), via branches (630) and (640), which communicate with each other at the level of the direction distributor (80), placed in position (803). In this way, the flow of oil from the hydraulic unit is increased by the flow of oil from the piston-chamber. If x is the ratio between the section of piston-chamber (54) and the section of rod (52), the flow from the hydraulic unit is multiplied by x, so that with such a differential assembly, the piston rod can descend at a speed x times faster than with a conventional assembly.

FIG. 6 illustrates the circuit when the hydraulic jack is in so-called compensation mode, activated while debris is being collected by scraping the bottom of the pot. The direction distributor (80) is excited to occupy position (801), which connects the main branch (630) with the pressure line (P) of the hydraulic unit, and the main branch (640) with the pot of the hydraulic unit, via the return line (R). Distributor (82) is in position (822) and distributor (81) is in position (811), which makes the pressure regulator (70) operational: if the pressure inside the rod-chamber (53) is higher than a given value, typically around 58 bar, oil runs out of rod-chamber (53) towards piston-chamber (54). If, on the other hand, the pressure inside the rod-chamber (53) is lower than this given value, oil from the hydraulic unit feeds said rod-chamber.

If the collection unit, during scraping, is no longer in contact with the bottom of the pot, the pressure in the chamber on the rod side (53) increases because the jack must support a load corresponding to the weight of the collection unit, which is higher than the predetermined load. The pressure regulator control system compares the load supplied by the setpoint spring (71) with the load due to the pressure in branch (72) which is connected to the chamber on the rod side (53) via part (632′) of the second sub-branch, distributor (82) in position (822) and the end portion (633). If the setpoint load is lower, the regulators brings, via outlet (73), part (632′) of the second sub-branch into communication with branch (642) of the first portion of the circuit (64), so that the regulator becomes passing between the rod-chamber (53) and the tank of the hydraulic unit, via the return line (R). In this way, the pressure in the chamber rod decreases and the apparent weight of the collection unit increases once more.

Conversely, if the collection unit, during scraping, presses too hard on the bottom of the pot, the pressure in the chamber on the rod side (53) is lower than the predetermined load. The pressure regulator control, which compares the load supplied by the setpoint spring (71) with the load due to the pressure in branch (72) which communicates with the chamber on the rod side (53), then brings, via outlet (74), part in (632′) of the second sub-branch into communication with the other part (632) of the second sub-branch, so that the regulator becomes passing between the rod-chamber (53) and the pressure line (P) of the hydraulic unit. In this way, the pressure in the chamber rod (53) increases and the apparent weight of the collection unit decreases.

FIG. 7 illustrates the circuit when the hydraulic jack raises rod (52). The direction distributor (80) is excited to occupy position (801), which connects the main branch (630) with the pressure line (P) of the hydraulic unit, and makes the main branch (640) communicate with the tank of the hydraulic unit, via the return line (R). Distributor (82) is in position (821) and distributor (81) is in position (812), which makes the pressure regulator (70) inoperative. Oil under pressure goes through the main branch (630), passes through the distributor (81) in position (812) and joins portions (631″) and (633) via the check valve (91), to feed the rod-chamber (53). As the piston rises, the oil in the piston-chamber (54) is sent out to the return line (R) of the hydraulic unit, via the main branch (640).

1. A collection unit designed to collect the solid debris and mud in the liquid media of a cell for producing aluminum, such as the electrolytic bath and the molten metal, in particular a crust shovel designed for cleaning anode holes, comprising:
a) a vertical mast actuated by a first actuator configured to be used to move said vertical mast in the vertical direction;
b) a frame fixed onto said vertical mast;
c) at least one articulated bucket, rotatable around a substantially horizontal axis, fitted to said frame, with a substantially horizontal leading edge actuated by a second actuator, interdependent with said frame, and configured to cause said bucket to adopt a rotary movement around said substantially horizontal axis,
wherein said first actuator is composed of at least one hydraulic jack which includes a body, a piston together with a rod and a chamber on a rod side, and which is powered by a hydraulic system arranged so that, at least when the second actuator is activated, oil pressure in the chamber on the rod side is maintained at a substantially constant value allowing said hydraulic jack to support a load corresponding to the weight of said collection unit, less a load of predetermined value that is lower than 1000 daN.

2. The collection unit according to claim 1 further comprising a portion of a circuit which is configured to feed said chamber on the rod side, and a pressure regulator which makes it possible to maintain the pressure within said chamber on the rod side in the vicinity of said substantially constant value.

3. The collection unit according to claim 1, wherein said rod of said hydraulic jack is interdependent with said vertical mast.

4. The collection unit according to claim 1, wherein said first actuator is a double-acting jack.

5. The collection unit according to claim 1 further comprising at least a second articulated bucket fitted to said frame and wherein the at least one articulated bucket and the at least a second articulated bucket are laid out symmetrically in relation to a substantially vertical plane and articulated, the at least one articulated bucket rotatable around a first substantially horizontal axis and the at least a second articulated bucket rotatable around a second substantially horizontal axis, each bucket having a leading edge opposite the leading edge of the other bucket.

6. The collection unit according to claim 5, in which the second actuator, interdependent with said frame, is configured to causes the at least one articulated bucket and the at least a second articulated bucket to make a substantially symmetrical rotation movement in relation to the substantially vertical plane, so that the solid debris located between the two buckets is trapped by said buckets.

7. The collection unit according to claim 1, wherein said first actuator is a double-acting jack with a second chamber, wherein the second chamber and the chamber on the rod side are connectable, via a distributor, to a pressure line or a return line of a hydraulic unit, and further comprising a feeding circuit including several portions of circuits which make it possible to provide the following hydraulic supply configurations:
a) a differential configuration, in which the two chambers are connected to the hydraulic unit, allowing the vertical mast to descend at high speed;
b) a configuration corresponding to a rest position;
c) a configuration in which the chamber on the rod side is connected to the hydraulic unit, corresponding to an upward movement of the collection unit; and
d) a compensation configuration, corresponding to a phase when the collection unit scrapes a bottom of the cell, in which the pressure in a first portion of a circuit feeding the chamber on the rod side is controllable so as to be maintainable around a value corresponding to the weight of said collection unit, less a load of predetermined value lower than 1000 daN.

8. The collection unit according to claim 7, wherein the second chamber is on the piston side and wherein said hydraulic system includes a second portion of the circuit, and wherein the first portion of the circuit and the second portion of the circuit are configured to feed the chamber on the rod side and the second chamber on the piston side of the double-acting jack, and wherein
a) the first portion of the circuit includes a main branch, a first end of which is connected to said distributor and a second end of which splits into two branches, the first branch being connected to the second chamber on the piston side of the at least one hydraulic jack, the second branch of which is connected to a pressure regulator;
b) the second portion of the circuit including a main branch a first end of which is connected to the distributor and a second end of which is splits into a first and a second sub-branch, each of which includes a two-position distributor, and wherein the first sub-branch is associated with a load-retaining means and the second sub-branch is associated with a pressure regulating device, and wherein the first sub-branch and the second sub-branch meet to make up an end portion, which feeds the chamber on the rod side of said hydraulic jack.

9. A service module designed to be used in a plant for the production of aluminum by igneous electrolysis and comprising a carriage and handling and servicing devices, wherein the service module further includes a collection unit according to claim 1.

10. A Pot Tending Assembly for a plant producing aluminum by igneous electrolysis including an overhead travelling crane characterized in that the pot tending assembly includes also at least one service module according to claim 9.

11. A method comprising: use of a service module according to claim 9 for servicing work on electrolytic cells designed for the production of aluminum by igneous electrolysis, in particular for cleaning the anode holes.

12. The collection unit of claim 1 wherein the load of predetermined value is between 200 and 600 daN.

13. The collection unit of claim 7 wherein the load of predetermined value is between 200 and 600 daN.
